(19) United States
(12) Patent Application Publication
(10) Pub. No.: US 2018/0322815 A1
(43) Pub. Date: Nov. 8, 2018

(54) DISPLAY DEVICES AND METHODS

(71) Applicant: K-International, Inc., Waukegan, IL (US)

(72) Inventor: Michael J. White, Ripon, WI (US)

(73) Assignee: K-International, Inc., Waukegan, IL (US)

(21) Appl. No.: 15/988,364

(22) Filed: May 24, 2018

Related U.S. Application Data
(60) Provisional application No. 62/477,013, filed on Mar. 27, 2017.

(51) Int. Cl. G09F 7/18

(52) U.S. Cl. CPC G09F 7/18; G09F 7/10

(57) ABSTRACT

A sign mounting system includes a mounting and holding apparatus having a mounting portion configured for mounting at a mounting location. The mounting portion may a holder selected from available holders that include hooks, magnets, clips, a suction cup, a mounting flange, etc. A holder is connected to the mounting portion. The holder may have a hinge. The holder has a frame gripper shaped with arms and inwardly angled ends on the arms that engage a side of a frame having bevels. The frame holds a sign or indicia. The frame may be mounted in the frame gripper in different orientations.

### CROSS-REFERENCE TO RELATED APPLICATION

The present non-provisional application claims the benefit of U.S. Provisional Patent Application Ser. No. 62,477,013 filed Mar. 27, 2017, which provisional application is incorporated herein by reference in its entirety.

### BACKGROUND OF THE INVENTION

### Field of the Invention

The present invention relates generally to a method and apparatus for display, and more particularly to a method and apparatus for attaching signs, objects, and other indicia to a mounting location for display.

### Description of the Related Art

Signs are used in stores, warehouses, storerooms, stock rooms, bookstores, libraries, and other facilities to indicate the locations of items or categories of items, or to otherwise provide directions or information. Shelves, racks, cabinets, or other structures may be provided for holding the items in the facility. The signs may be placed on the shelving units, racks, cabinets or other such item supports, or may be place on walls, pegboard, slot board, doors, windows or other structures or surfaces in or around a facility. The different sign mounting locations may require the use of different types of signs for the different mounting locations. It would be beneficial if a same type of sign could be provided at each mounting location in a facility regardless of the type of mounting required for the sign.

Items in stores, warehouses, storerooms, stock rooms, bookstores, libraries, and other facilities are occasionally moved from place to place and it is therefore necessary to move the signs which indicate the item locations. It would be beneficial if the signs that indicate the item locations could be unmounted and moved to the different locations as needed. It would be beneficial if the same sign could be moved to a different location that might use a different type of sign mounting.

These are but a few examples of where and how signs may be used. Other examples will be apparent to those of skill in this art.

### SUMMARY

An apparatus for mounting and holding a sign or other indicia is provided. The sign may be provided in a frame. The apparatus may have a mounting portion configured for mounting to a mounting location and a holder configured for holding the frame. The frame may be held in the holder in different positions and orientations. The mounting portion may be of a modular construction. Different mounting portions may be selected depending on the type of mounting location, the sign orientation, and sign position at which the sign is to be mounted. Different configurations of mounting portions may be selected for a holder. Different holders may be selected depending on, for example, flexibility or bending of the holder. Different frames may be selected for mounting in the holder. The frame held in the mounting apparatus may be exchanged for a different frame, such for frame of a different color, shape or size, or a frame for holding a different sign. The sign held in the frame may be exchanged for a different sign in the frame.

The sign mounting and holding apparatus may be readily mounted to a mounting location and may be readily removed from the mounting location, such as for moving sign to a different mounting location. A plurality of different mounting portions are provided, each configured for mounting at a type of mounting location. The different mounting portions may be selected by a user as desired. The holder may be configured to hold the sign frame at any of several orientations or to hold any of several sizes and shapes of sign frame.

Examples of embodiments of the mounting and holding apparatus are shown in the drawings and described in this specification. Examples of other embodiments are shown in the U.S. Provisional Patent Application Ser. No. 62,477,013 filed Mar. 27, 2017, which provisional application is incorporated herein by reference in its entirety.

### BRIEF DESCRIPTION OF THE DRAWINGS

FIG. 1 is a perspective view from the front, top, left side of a framed sign held in a sign mounting and holding apparatus mounted on an upright of a support structure;

FIG. 2 is a perspective view from the front, bottom, left side of the framed sign held in a sign mounting and holding apparatus on an upright support;

FIG. 3 is an enlarged fragmentary view of the sign mounting and holding apparatus mounted on the upright support and holding a framed sign;

FIG. 4 is a cross sectional view through the frame and upright support showing the sign mounting and holding apparatus mounted to the upright support;

FIG. 5 is a perspective view of the sign mounting and holding apparatus from the back, top, left side;

FIG. 6 is a perspective view of the sign mounting and holding apparatus from the front, top, right side;

FIG. 7 is a top plan view of the sign mounting and holding apparatus;

FIG. 8 is a side elevational view of the sign mounting and holding apparatus from the left side;

FIG. 9 is a front elevational view of the sign mounting and holding apparatus;

FIG. 10 is a fragmentary perspective view of an under-shelf-mounted embodiment of the sign mounting and holding apparatus;

FIG. 11 is a front elevational view of the under shelf-shelf-mounted embodiment of the mounting and holding apparatus;

FIG. 12 is a perspective view from the front, top, left side of the under shelf-shelf-mounted embodiment of the mounting and holding apparatus;

FIG. 13 is a perspective view from the back, top, left side of the under shelf-shelf-mounted embodiment of the mounting and holding apparatus;

FIG. 14 is a top plan view of the under shelf-shelf-mounted embodiment;

FIG. 15 is a side elevational view from the left side of the under shelf-shelf-mounted embodiment;

FIG. 16 is an enlarged fragmentary view of a magnet holder embodiment of the mounting and holding apparatus shown mounted to a vertical mounting location and holding a framed sign;

FIG. 17 is a perspective view from the front, top, left side of the magnet holder embodiment of the mounting and holding apparatus;

FIG. 18 is a perspective view from the back, top, right side of the magnet holder embodiment;

FIG. 19 is a top plan view of the magnet holder embodiment;

FIG. 20 is a side elevational view from the left side of the magnet holder embodiment;

FIG. 21 is a front elevational view of the magnet holder embodiment;

FIG. 22 is a perspective view from the front, top, left side of a flush holder embodiment of the mounting and holding apparatus showing the framed sign mounted on a window;

FIG. 23 is a fragmentary perspective view from the front, top, left side of the flush holder embodiment of the mounting and holding apparatus showing the mounting and holding apparatus being mounted to a surface using a screw;

FIG. 24 is an enlarged exploded view showing the flush holder embodiment and a suction cup mount;

FIG. 25 is a perspective view, partially in phantom, from the front, top, left side of the flush holder embodiment;

FIG. 26 is a perspective view from the back, top, left side of the flush holder embodiment;

FIG. 27 is a top plan view of the flush holder embodiment; and

FIG. 28 is a side elevational view from the left side of the flush holder embodiment.

### DETAILED DESCRIPTION OF THE PREFERRED EMBODIMENTS

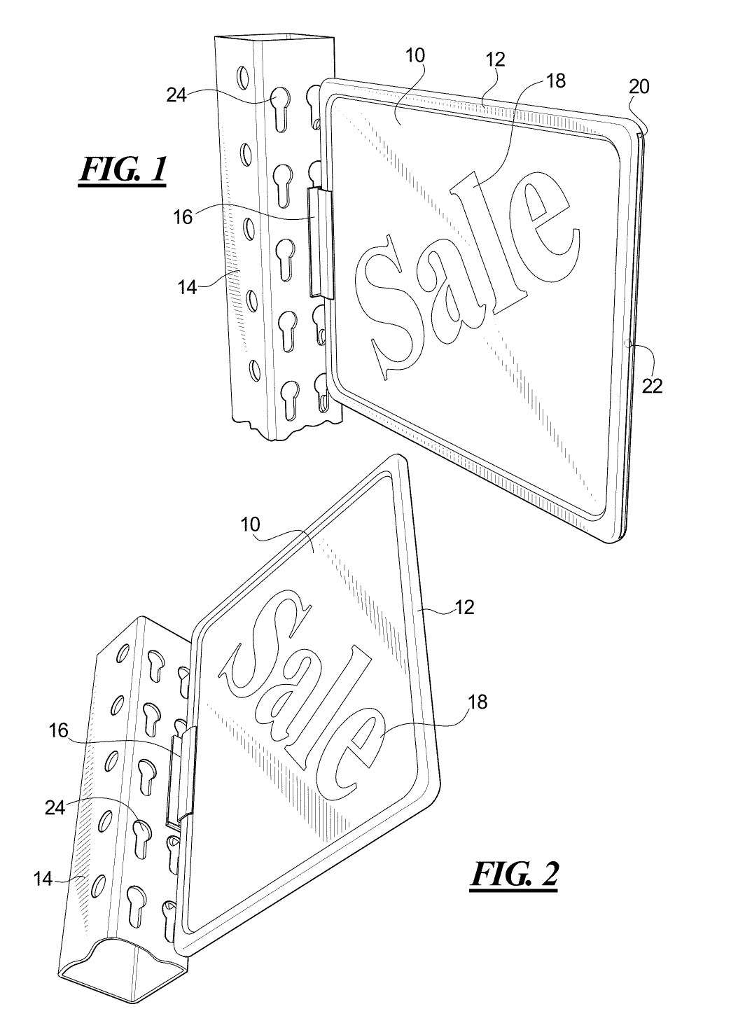

Referring first to FIG. 1, a sign 10 is mounted in a frame 12 at a location where the sign is visible to users, such as in a store, stockroom, warehouse, library, or other facility where a sign might be needed. The sign 10 is mounted to a mounting location that is shown in the figure as an upright support 14 using a mounting and holding apparatus 16.

In particular, the sign 10 may be of sheet material such as paper, cardboard, plastic sheet, foam-core board, laminates, wood, metal, or other material on which information or indicia 18 has been provided by marking, printing, painting, forming or other marking means. The frame 12 may hold a clear cover of plastic, glass or clear film that extends over the sign 10. The sign 10 may be one sided or two sided, and may be provided in a frame 12 that is open at both sides. The sign 10 is held in the frame 12 in a landscape orientation (the long dimension of the rectangular frame extending horizontally). The sign 10 may direct users to an aisle in a store, a warehouse, or library, or may direct users to a restroom, exit, cashier, information or customer service counter, or other location. In the example, the sign 10 announces a sale. New products may be announced, features of a product promoted, or other information provided.

The frame 12 surrounds the sign 10 on four sides to provide an attractive appearance and visual effect for the sign 10. The frame 12 may be provided in a color to call attention to the sign, to match the colors of other frames of other signs, or to provide a color code to indicate a location or provide other information. For example, a customer may look for yellow framed signs for one type of product and blue framed signs for another type of product. The mounting and holding apparatuses 16 in which the frame is held may match the color of the frame 12 or may be of a coordinating or contrasting color.

The frame 12 has a slot 20 into which sign 10 may be inserted and through which the sign 10 is removed to change the sign 10. The slot 20 includes an internal projection 22 extending into the slot 20 to prevent the sign 10 from inadvertently slipping through the slot 20 and out of the frame 12. The slot 20 is shown at the outside edge of the frame 12 in the illustration, to permit changing of the sign 10 in the frame 12 without removal of the frame 12 from the holder 28. The frame 12 may instead be mounted in the mounting and holding apparatus 16 with the slot 20 on the inside edge, so that the slotted edge is gripped in the mounting and holding apparatus 16. The sign 10 can still be changed in this orientation by removing the frame 12 from the mounting and holding apparatus 16, exchanging the sign 10, and reattaching the frame 12 in the mounting and holding apparatuses 16.

The frame 12 is held in the mounting and holding apparatus 16 in the landscape orientation with the long edge of the rectangular frame 12 extending horizontally. The mounting and holding apparatus 16 is affixed to the short side of the frame 12 at a location about midway along the side of the frame 12. The mounting and holding apparatus 16 may be mounted closer to the top or to the bottom of the frame edge as desired.

The upright support 14 on which the mounting and holding apparatus 16 is mounted includes keyhole-shaped openings 24 in a vertical alignment along the upright support 14. The keyhole-shaped openings 24 provide attachment points for shelves or other items in a warehouse or store. The mounting and holding apparatus 16 is configured to affix the sign 10 to the upright support 14 using the keyhole shaped openings 24. The illustrated mounting and holding apparatus 16 will connect to the keyhole-shaped openings whether they are oriented as shown or in an inverted orientation.

In FIG. 2, the sign 10 and frame 12 are fastened in a portrait orientation (the long dimension extending vertically) by fastening long side of the frame 12 in the mounting and holding apparatus 16. The illustration shows the mounting and holding apparatus 16 attached midway along the long side of the frame 12. The frame 12 may instead be mounted with the mounting and holding apparatus 16 nearer the top or the bottom of the frame 12. The frame 12 may be provided with two or more of the mounting and holding apparatus 16 attached to the frame 12 along an edge thereof. The portrait orientation of the sign 10 may use two of the mounting and holding apparatuses 16, one nearer the top and one nearer the bottom along the long edge. For taller signs mounted in a vertical orientation, three or more of the mounting and holding apparatuses 16 may be attached along the edge of the frame 12. The slot 20 is at the top in this view, or may be along the long side, as desired. Whichever orientation is selected, the mounting and holding apparatuses 16 securely engages the frame 12 without obscuring the sign 10.

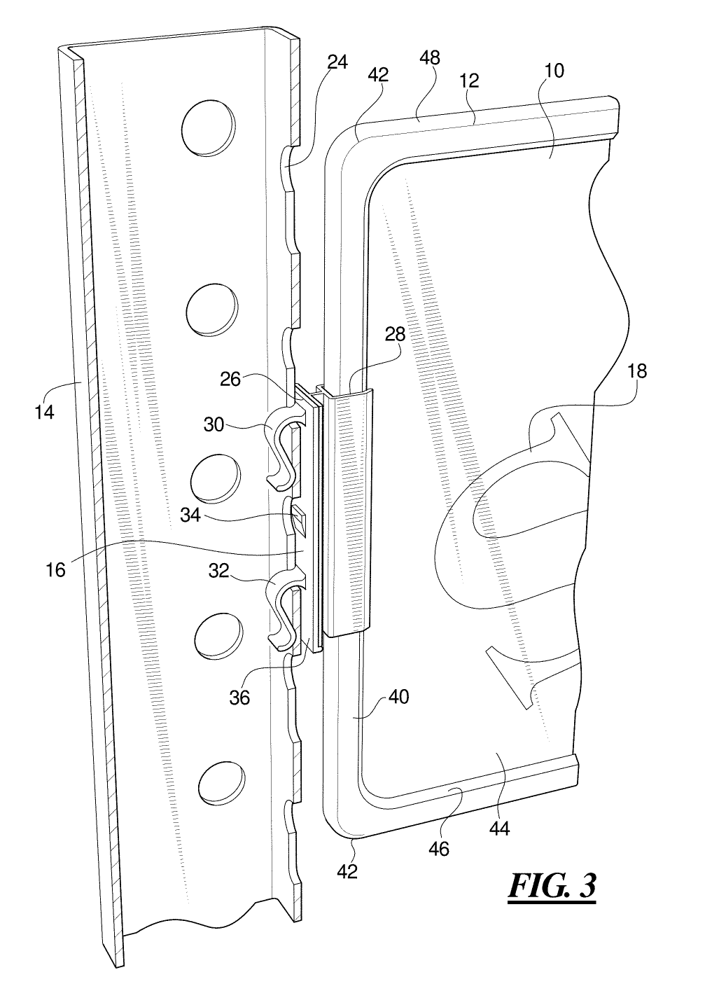

Turning to FIG. 3, the mounting and holding apparatuses 16 has a mounting portion 26 that is attached to the upright support 14 and a holder 28 that holds the frame 12. The mounting portion 26 and the holder 28 may be provided as modular items that are affixed to one another in different combinations as desired. As will be shown, other mounting portions or other holders may be provided. The mounting portion 26 is configured for attachment to a mounting location having holes through a relatively thin walled member. The mounting portion 26 has first and second hooks 30 and 32 spaced at approximately the spacing of the openings 24 in the upright support 14. The hooks 30 and 32 extend through the openings 24 and engage an inside surface of the upright support 14. The hooks 30 and 32 are S-shaped and configured to accommodate different thicknesses in the vertical support 14 or other mounting location by flexing while maintaining the lower, distal end of the hooks 30 and 32 pressed against the inside surface. Other shapes of hooks may be provided as needed.

A ramp-shaped projection 34 is located to engage into one of the openings 24 when the hooks 30 and 32 are engaged in the openings 24 and in a seated position at lower ends of the openings 24. The ramp-shaped projection 34 locks the mounting and holding apparatus 16 in place on the upright support 14 and prevents inadvertent dislodgement of the mounting and holding apparatus 16 from the mounting location. Tension by the hooks 30 and 32 on the inside surface of the upright support 14 may cause the mounting and holding apparatus 16 to snap into place once moved to an engaged position. Removal of the mounting and holding apparatus 16 from the upright support 14 may be accomplished by pulling the mounting and holding apparatus 16 outward away from the upright support 14 to disengage the ramp-shaped projection 34 from the opening 24 and then by moving the mounting and holding apparatus 16 upward until the hooks 30 and 23 pass through the openings 24. The hooks 30 and 32 are sized to pass through the openings 24 for mounting and unmounting.

The hooks 30 and 32 as well as the ramp-shaped projection 34 extend from a base plate 36. The hooks 30 and 32 pull the base plate 36 against the outside surface of the upright support 14. The mounting and holding apparatus 16 has a holder 28 mounted to the base plate 36 on the opposite side from the hooks 30 and 32. The holder 28 is configured to hold the frame 12. The frame 12 has at least one straight side 40 to which the holder 28 is attached. The holder 28 is straight in the illustrated embodiment. A curved holder may be provided for attachment to a curved frame. For example, a circular or partially circular frame may be attached to a holder having an arc shape of the same radius as the circular frame. Other shapes of frames and holders are possible within the scope of this invention.

The illustrated frame 12 is of a square or rectangular shape having four frame sides 40 connected by rounded corners 42. The frame 12 has a central opening or window 44 where the sign 10 is visible. The frame 12 may have a window opening 44 at both sides and may be provided with a sign 10 at both sides. The inside edges of the frame 12 around the window opening 44 are provided with a beveled edge 46. The frame 12 has uniformly shaped and sized sides 40 so that the holder 28 may be attached at any side 40 of the frame and at any position along the side 40. The frame 12 has a rounded outer edge 48 at the outer perimeter of the frame 12. The rounded outer edge 48 aids in fitting the frame 12 into the holder 28 by moving the holder 28 to an open position when the frame 12 is pressed into the holder 28.

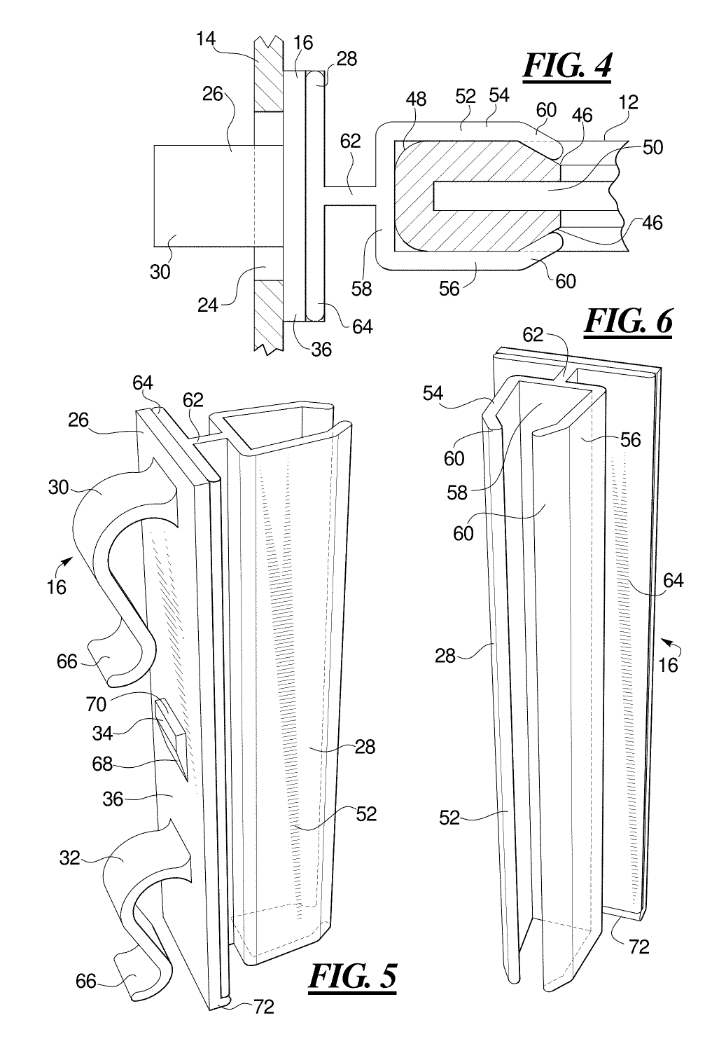

FIG. 4 shows the frame 12 in the holder 28. The frame 12 has a recess, also known as a rabbet 50, into which the sign 10 and any other contents of the frame 12 fits. The rabbet 50 may be of a depth to fit a single thin sign 10 or may be thicker to accommodate a thick sign, two signs 10 facing opposite directions for both sides of the frame 12, signs with clear dust covers or clear sheets over the signs, signs with a backing sheet behind the signs, etc. The frame 12 has the beveled edges 46 on both opposite sides and the rounded outer edge 48.

The holder 28 engages the frame with a frame gripper 52. The frame gripper 52 is generally C-shaped in cross section and includes first and second arms 54 and 56 and a cross member 58 connecting the arms 54 and 56. The arms 54 and 56 have inwardly angled ends 60 that engage the beveled edges 46 of the frame 12. The inwardly angled ends 60 secure the fame 12 in the holder 28. The arms 54 and 56 are of a length to engage the beveled edges 46 without intruding into the window of the frame 12. The frame gripper 52 is formed of rigid plastic having sufficient resilience to permit the frame 12 to be inserted into the holder 28 yet rigid enough to hold the frame 12 while the frame is in the holder 28.

The holder 28 has a neck 62 that connects the frame gripper 52 to a holder base 64. The neck 62 of the illustrated embodiment includes a thin strip of material between the frame gripper 52 and the holder base 64. The holder base 64 is of a size and shape for attachment to the base plate 36 of the mounting portion 26. In certain examples, the holder base 64 is of the same size and shape as the base plate 36. The hook 30 extends from the base plate 36 through the opening 24 in the upright support 14.

The holder 28 may be provided in two embodiments, a hinged or flexible embodiment and a non-hinged or relatively inflexible embodiment. In the hinged embodiment, the neck 62 is formed of a flexible material such as a rubber or PVC material while the frame gripper 52 and the holder base 64 are formed of a more rigid plastic or other material. The holder 28 of the two materials may be formed in one piece by co-extruding the materials. The flexible neck 62 permits the frame gripper 52 and the frame 12 to flex relative to the mounting portion 26. For example, if the sign 10 is bumped by a person walking by, the frame 12 and the frame gripper 52 will bend relative to the mounting portion 26 and then spring back to a perpendicular position without dislodging the mounting and holding apparatus 16 from its mounting location and without dislodging the frame 12 from the mounting and holding apparatus 16.

Some users prefer the holder 28 without the flexible neck 62. For these users, an embodiment is provided with the frame gripper 52, the neck 62 and the holder base 64 formed of the same rigid plastic. Little flex is provided for the non-hinged holder 28.

The holder 28 of the illustrated embodiment is an extruded part and may be formed of a single plastic material to form the non-hinged embodiment. The hinged embodiment may be formed by co-extruding two materials so that the frame gripper 52 and the holder base 64 are formed of a rigid plastic and the neck 62 is formed of a flexible plastic such as PVC. The co-extruded different materials are fused to one another to provide a strong unitary structure capable of withstanding bending and flexing without breaking.

FIG. 5 shows the mounting and holding apparatus 16 in an unmounted condition and without a frame in the frame gripper 52. The base plate 36 is formed of one piece with the hooks 30 and 32 and the ramp-shaped projection 34 to provide the mounting portion 26. The mounting portion 26 may be molded of a rigid plastic. The S-shaped hooks 30 and 32 are flexible to accommodate different thicknesses of mounting locations to which the mounting portion may be attached. The hooks 30 and 32 each have a curved free end 66 that may help the hooks slide onto the back surface of thicker mounting locations. The ramp-shaped projection 34 has a ramp portion 68 at a lower end in a direction of installation and a flat portion 70 at an upper end that slides along the outside surface of the mounting location and has an edge to engage an edge of an opening 24.

In FIG. 6, the holder 28 has the first and second arms 54 and 56 that are supported on the cross member 58 to provide the frame gripper 52. The arms 54 and 56 are angled inward toward one another when in a relaxed state without the frame 12 being inserted into the frame gripper 52. Insertion of the frame 12 into the frame gripper 52 biases the arms 54 and 56 against the front and back sides of the frame 12 to prevent slipping of the frame 12 within the frame gripper 52. The force of the arms 54 and 56 together with the inwardly angled ends 60 on the beveled edges 46 holds the frame 12 securely in the mounting and holding apparatus 16.

The mounting and holding apparatus 16 is of a modular construction. The mounting portion 26 may be provided with either the hinged holder 28 (having the flexible neck 62) or the non-hinged holder 28 (with a relatively inflexible neck 62), as desired. The option to provide either the hinged or non-hinged holder 28 for the same mounting portion 26 is accomplished by forming the mounting portion 26 and the holder 28 in two separate parts. The mounting portion 26 and the desired holder 28 may be attached to one another using adhesive or other attachment means. As seen in FIGS. 5 and 6, the base plate 36 of the mounting portion 26 is a flat rectangular member. The holder base 64 of the holder is also a flat rectangular member of a similar size and shape. An adhesive such as a liquid, gel, or foam sheet adhesive may be applied between the base plate 36 and the holder base 64 to secure the mounting portion 26 to the desired holder 28.

The mounting portion 26 should be aligned with the holder 28 when assembled to ensure that the frame 12 and sign 10 are straight when mounted at a mounting location. An alignment edge 72 is provided at the lower end of the base plate 36. The base plate 36 and the holder base 64 are attached by applying an adhesive between them. With the adhesive on one or both of the base plate 36 and the holder base 64, the lower edge of the holder base 64 is brought into contact with the alignment edge 72 while the parts are at an angle to one another. The base plate 36 and the holder base 64 are aligned with one another and then pivoted toward one another at the alignment edge 72 to bring the plate-shaped members into contact with the adhesive between them. Alignment of the parts is assured.

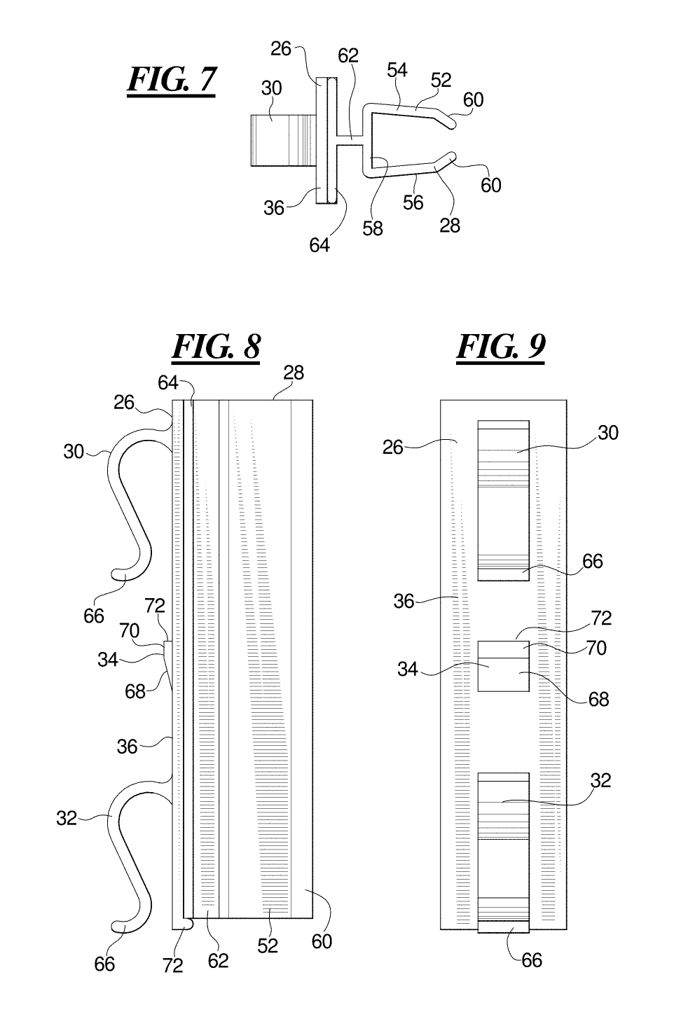

In FIG. 7, the inwardly angled relaxed state of the first and second arms 54 and 56 is apparent. The neck 62 spaces the frame gripper 52 from the holder base 64 to permit flexing of the frame gripper 52 relative to the holder base 64 in embodiments having a flexible neck 62. The hooks 30 and 32 are aligned with the frame gripper 52 when the holder base 64 and the base plate 36 have been aligned with one another. This assures that the sign 10 is in line with the holes 24 in the upright support 14.

FIG. 8 shows that the hooks 30 and 32 are adjacent the top and bottom of the mounting and holding apparatus 16. The ramp-shaped projection 34 is between the hooks 30 and 32. The alignment edge 72 is provided at the bottom edge of the base plate 36.

FIG. 9 shows the hooks 30 and 32 and the ramp-shaped projection 34 at the center axis of the base plate 36. The hooks 30 and 32 and the ramp-shaped projection 34 are narrower than the base plate 36 to fit through the openings 24 as the base plate 36 is mounted against the surface of the upright support 14.

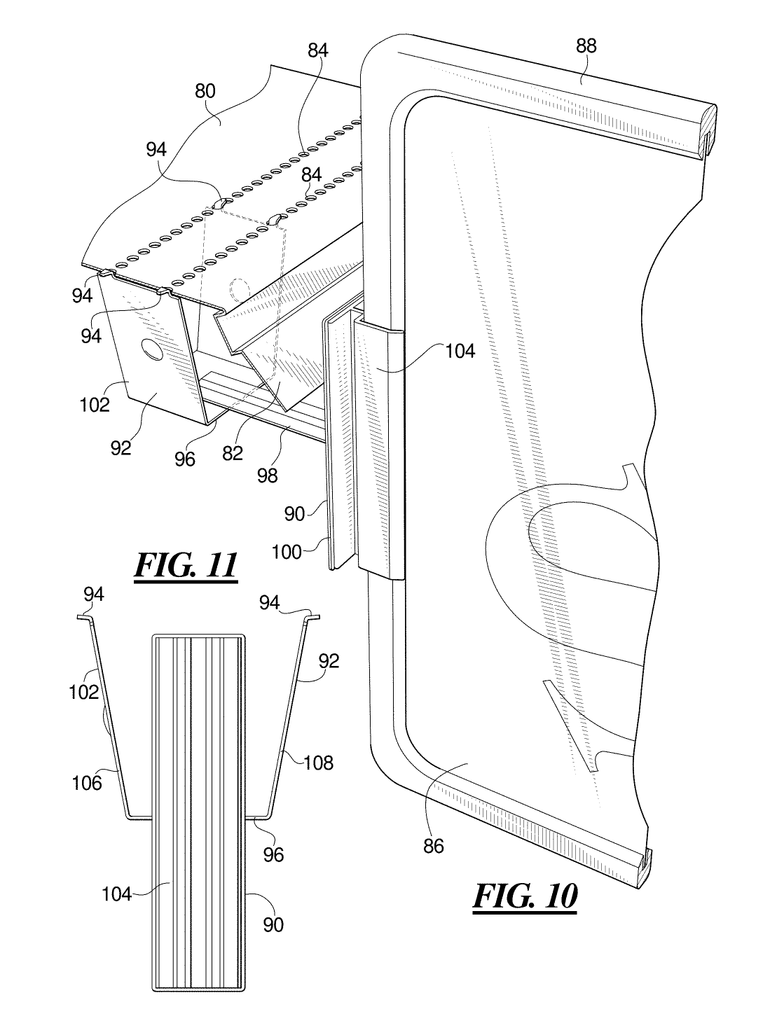

In FIG. 10, a store shelf 80 has a price channel 82 along the forward edge and rows of holes 84 running parallel to the edge. A sign 86 in a frame 88 has been mounted to the shelf 80 using an under-shelf mounting holder 90. The under-shelf mounting holder 90 includes a spring clip 92 that connects onto the underside of the shelf 80. The spring clip 92 has two pairs of tabs 94 that engage into the holes 84 from the underside of the shelf 80. A middle portion 96 of the spring clip 92 extends below the underside surface of the shelf 80 to clear the price channel 82. An extender 98 extends from the middle portion 96 to beyond the front edge of the shelf 80 and connects to a base plate 100. The spring clip 92, extender 98 and base plate 100 provide a mounting portion 102 of the mounting and holding apparatus which has been configured in this embodiment to provide the under-shelf mounting holder 90. A holder 104 may be attached to the mounting portion 102 as an assembly of modular parts to provide the under-shelf mounting holder 90.

The holder 104 of FIG. 10 may be the same holder or of the same construction as the holder 28 of FIGS. 1-9. The user or the supplier or other party may select either the mounting portion 26 or the mounting portion 102 for connection to the holder 28 or 104. The holder 104 may be either a hinged or non-hinged holder, just as the holder 28 described above.

FIG. 11 shows that the holder 104 is disposed below the top of the spring clip 92. The spring clip 92 includes spring arms 106 and 108 extending outward from one another. The holder 104 provides the front surface of the under-shelf mounting holder 90.

FIG. 12 shows the under-shelf mounting holder 90 with the spring clip 92 spaced from the holder 104 by the extender 98. The spring arms 106 and 108 of the spring clip 92 include grip portions 110 and 112 that are grasped by a user to squeeze the spring arms 106 and 108 toward one another for engaging the tabs 94 into the holes 84 and for releasing the tabs 94 from the holes 84. The grip portion 110 includes a raised projection at a center of the spring arm 106. The grip portion 112 includes an opening in the center of the spring arm 108. The raised projection 110 and opening 112 provide distinctive tactile sensations to the user as the under-shelf holder 90 is mounted or removed without direct viewing by the user.

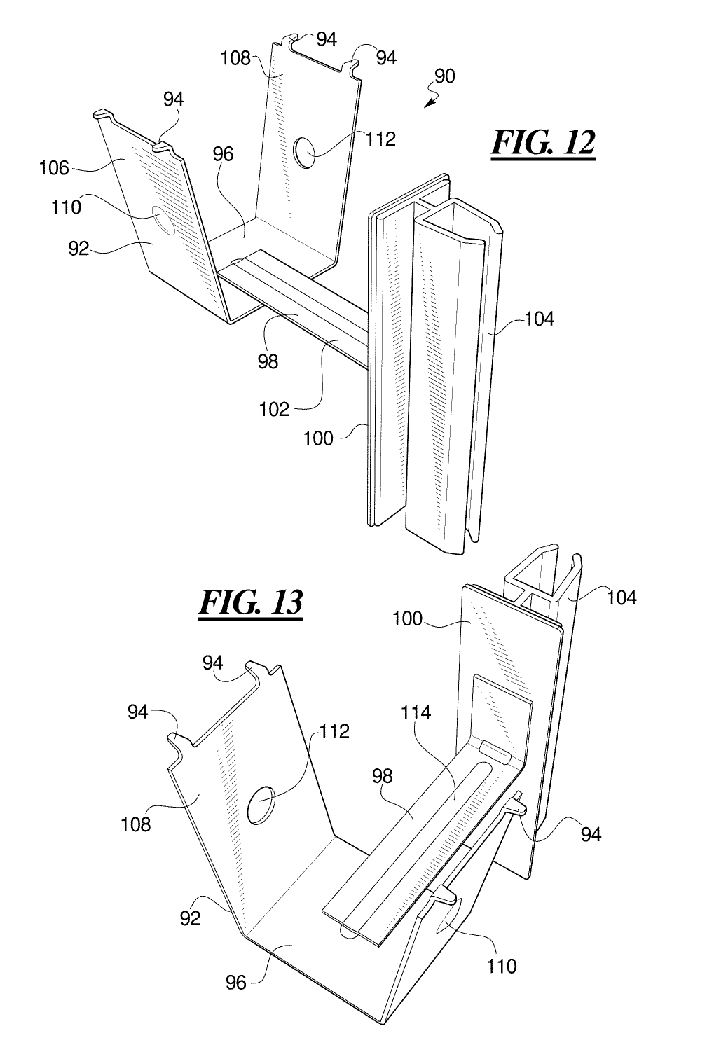

In FIG. 13, the extender 98 may be a metal strip that is connected from a center of the spring clip 92 to the center of the base plate 100. The spring clip 92, the extender 98 and the base plate 100 may be formed of sheet metal and may be affixed to one another by welding. A strengthening ridge 114 may extend along all or part of the extender 98.

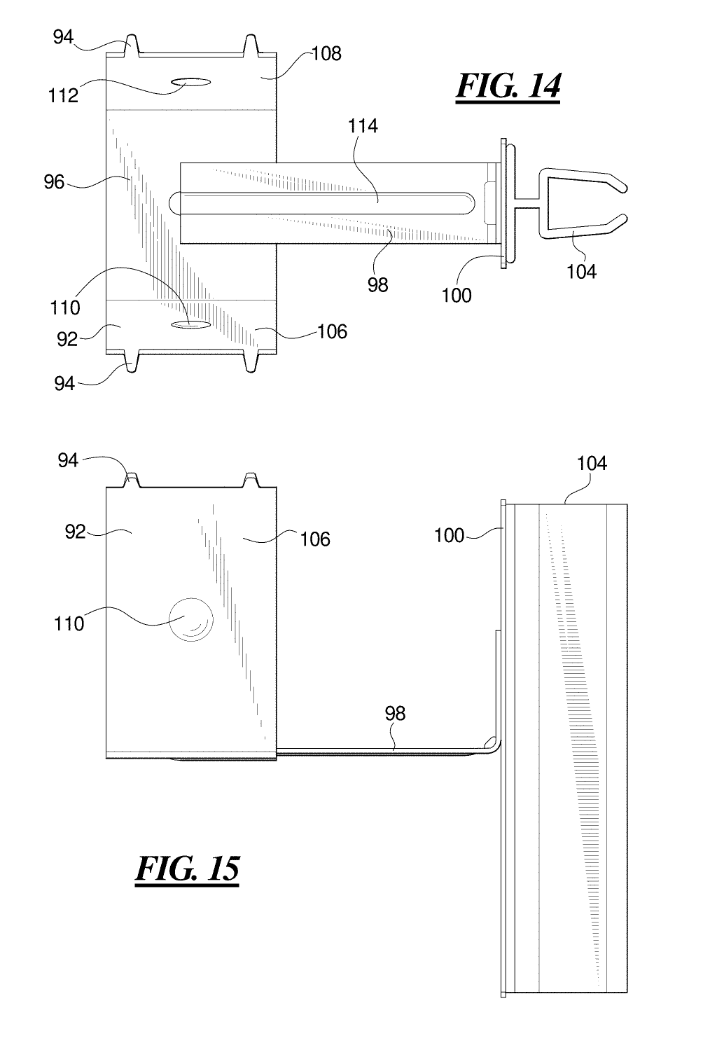

Turning to FIG. 14, the holder 104 with its frame gripper is aligned with the center of the spring clip 92 and is perpendicular with the spring clip 92 so that the sign is held in alignment and perpendicular with the shelf edge.

FIG. 15 shows the extender 98 attached about midway of or slightly above the midway part of the base plate 100 and holder 104. The tabs 94 extend above the upper edges of the spring arms 106 and 108 so as to extend into the holes 84 in the shelf 80.

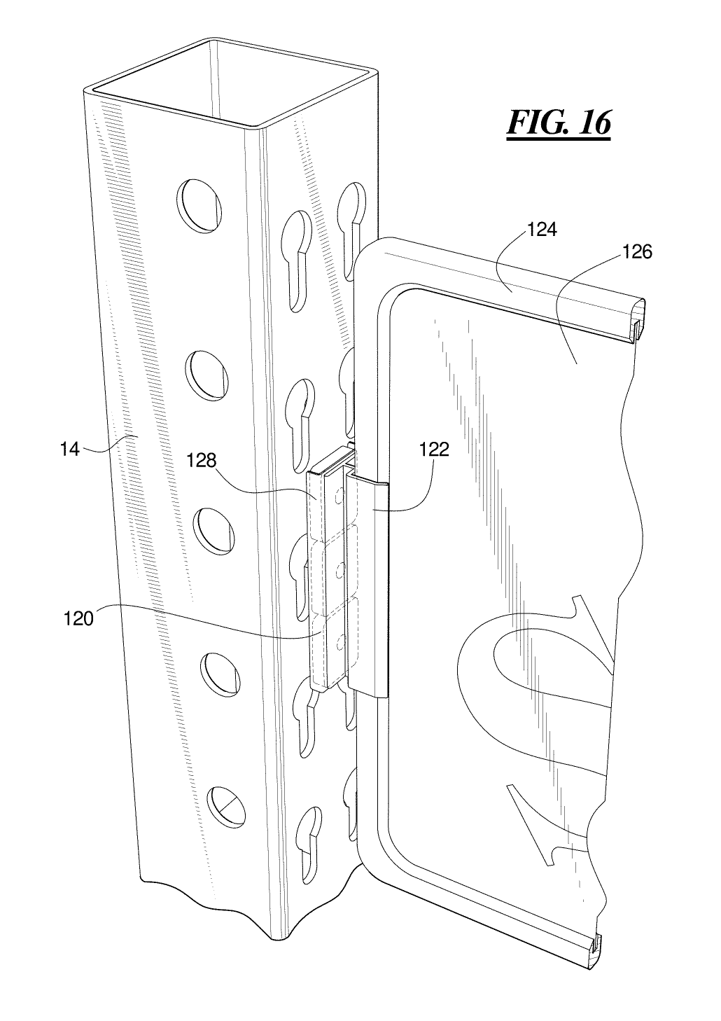

With reference to FIG. 16, a magnet holder 120 includes a mounting portion 128 and a holder 122 into which is attached a frame 124 that is holding a sign 126. The frame 124 and sign 126 may be the same sign or a similarly constructed frame and sign as in the other embodiments described herein, thereby providing a modular sign display. The holder 122 may be the same or a similarly constructed holder as described herein. For example, the holder 122 may include the hinged flexible neck or may be formed of a rigid material at the neck. The holder 122 has been selectively affixed to a mounting portion 128 for mounting at a magnetic mounting location. The mounting portion 128 includes magnets for magnetically engaging the mounting location.

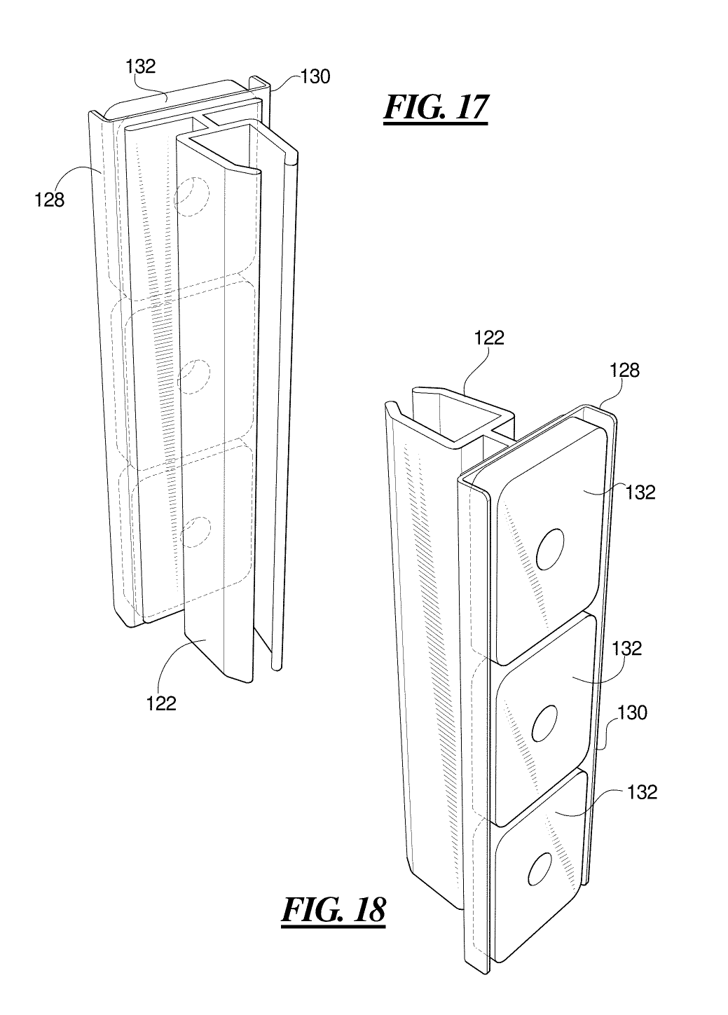

FIG. 17 shows the holder 122 mounted to the mounting portion 128 which includes a U-channel 130 formed of steel or other ferrous metal. The U-channel 130 partially encloses three magnets 132. The magnets 132 may be ceramic magnets and are formed with holes at the center of each magnet. The holder 122 is fastened to the U-channel 130 using an adhesive.

FIG. 18 shows the three magnets 132 mounted in the mounting portion 128. The magnets provide a strong attracting force for holding the framed sign securely in place to a magnetically attractive surface, such as a cabinet, beam, or other metal structure.

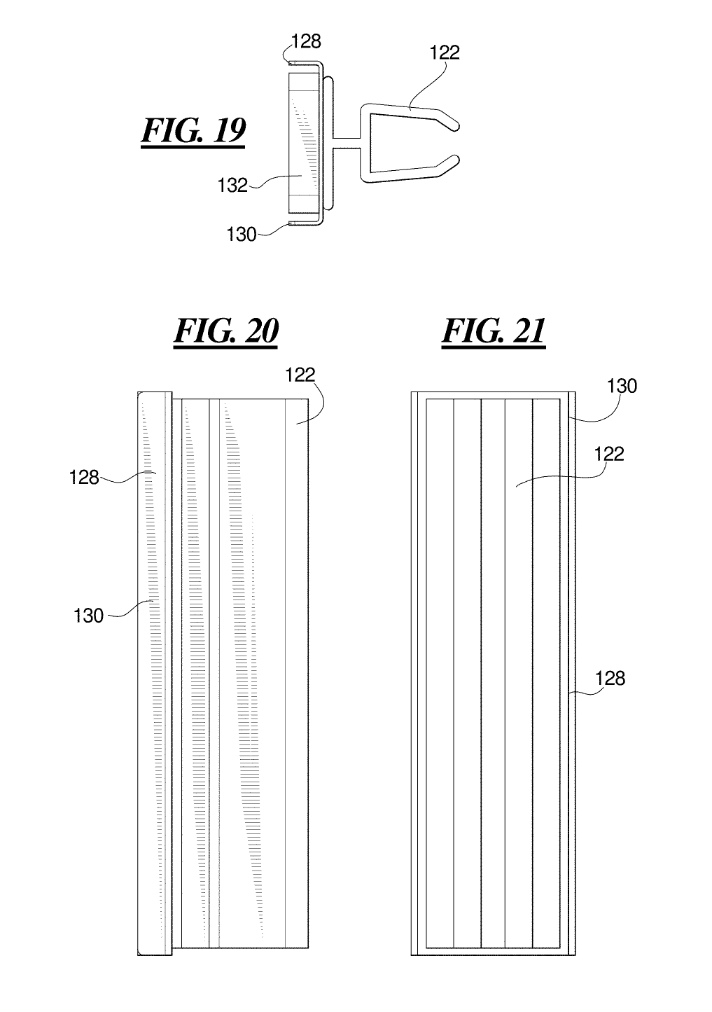

FIGS. 19, 20, and 21 show the arrangement of the holder 122 centered on the U-channel 130 to provide a modular mounting and holding apparatus that has been selectively configured for mounting to a magnetic mounting location. The U-channel 130 of the mounting portion 128 is larger than the holder base of the holder 122 in the illustrated embodiment. The mounting portion 128 is slightly longer and slightly wider than the holder base. The magnets 132 extend from the U-channel 130 so that the magnets 132 to contact a mounting surface instead of the U-channel 130. The holder 122 may be of the same construction as the previously described holders, including having the option of being hinged or non-hinged. Other features of the present device will be apparent from these and other figures.

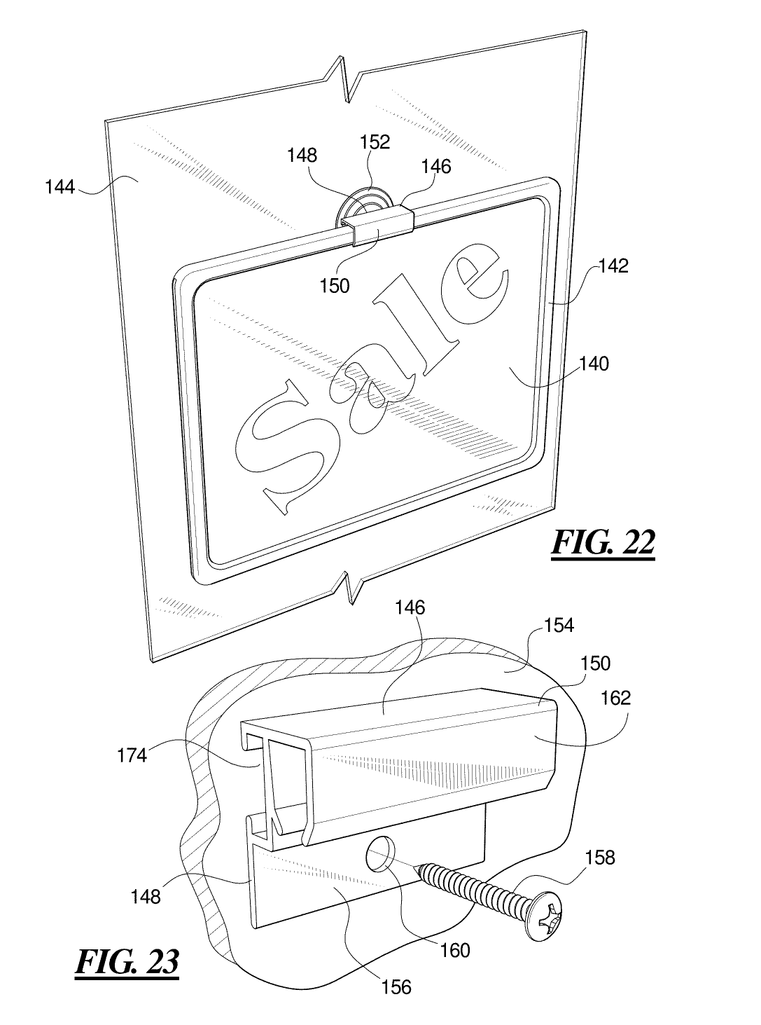

FIG. 22 shows a flush mount embodiment for mounting a sign 140 in a frame 142 flush to a surface 144, or at least parallel to the surface 144. The frame 142 is held in a mounting and holding apparatus 146 that is configured for flush-mounting of the framed sign 140 Like other embodiments of the mounting and holding apparatus, the mounting and holding apparatus 146 includes a mounting portion 148 and a holder 150 for holding the frame 142. The mounting portion 148 includes a suction cup 152 that attaches to a smooth surface 144, such as a window, metal cabinet, or smooth wall panel. The holder 150 is configured to engage the frame 142 so that the frame 142 is held parallel to the surface 144.

For the flush mount embodiment that is mounted to a wall or cabinet, a single sided sign 140 may be provided in the frame 142. If the flush mount embodiment is mounted to a window, whether to an external window or an internal window, the fame 142 may hold a two sided sign 140. One side of the sign 140 is visible on the front side of the frame 142, and the other side of the sign 140 is visible through the window.

With reference to FIG. 23, the flush mount embodiment of the mounting and holding apparatus 146 may be mounted to a surface 154 that may be porous or uneven such as a painted wall surface, wooden furniture or other surface. The mounting and holding apparatus 146 includes the same holder 150 as in FIG. 22, but the mounting portion 148 eliminates the suction cup 152 and instead uses a mounting flange 156 and a screw 158 to attach the mounting and holding apparatus 146 to the surface 154. The mounting flange 156 is configured to lie flush against the surface 154 and includes a hole 160 through which the screw 158 is inserted for fastening into the surface 154.

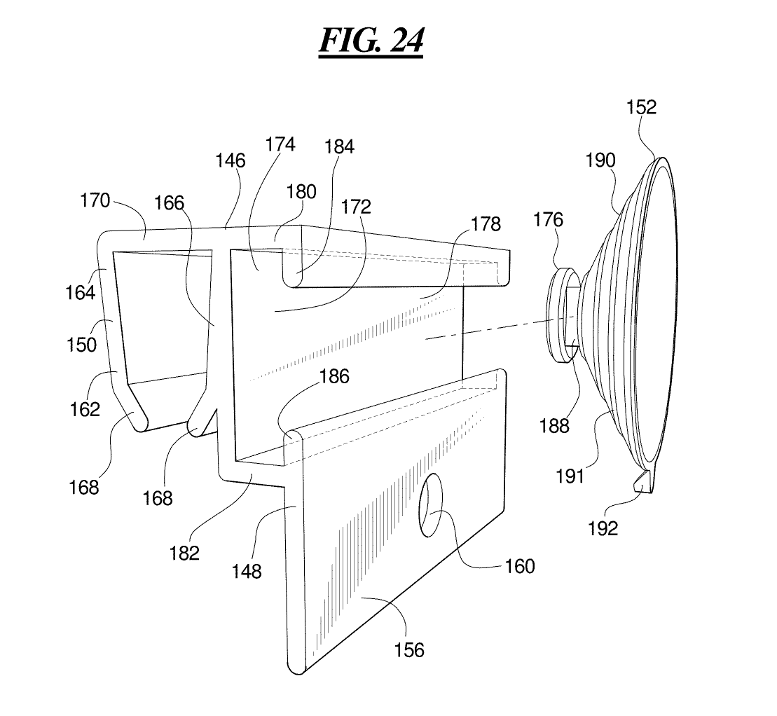

Turning to FIG. 24, the mounting and holding apparatus 146 includes the holder 150 oriented to hold the frame 142 in a position with the sign and frame parallel to the mounting surface. The holder 150 is formed primarily of a frame gripper 162 with first and second arms 164 and 166 that each have an inwardly angled end 168 and that are connected at their base by a cross member 170. The frame gripper 162 is shaped to engage the frame 142 along a side thereof so that the sign 140 is displayed in a position flat with the surface.

The mounting and holding apparatus 146 includes the mounting portion 148 which includes channel walls 172 configured to form a channel 174 for holding a button 176 of the suction cup 152. The channel walls 172 include a back wall 178, top and bottom walls 180 and 182, and button engaging flanges 184 and 186. The lower button engaging flange 186 is co-planar with the mounting flange 156. The back wall 178 forms part of the second arm 166 of the frame gripper 162. The second arm 166 and the back wall 178 share the same parts.

With the suction cup 152 removed, the mounting portion 148 may be mounted against a surface and fastened in place by a screw 158, nail or other fastener extending through the hole 160. The use of a fastener 158 extending through the hole 160 in the mounting flange 156 permits the flush mount embodiment to be mounted to most surfaces. It is also possible to apply an adhesive to the rear surface of the mounting flange 156 to adhesively attach the flush mount embodiment to a surface. To mount the mounting portion 148 to a glass pane 144 or other smooth surface, the button 176 of the suction cup 152 is inserted into the channel 174, for example by sliding the button 176 into an end of the channel 174. The suction cup 152 has a stem 188 that connects the button 176 to a cup 190. The cup 190 has concentric ridges 191 to control flexing of the cup 190. A release tab 192 is provided at the edge of the cup 190 by which a user may release the suction between the cup 190 and the surface 144 by permitting to access the space between the cup 190 and the surface 144.

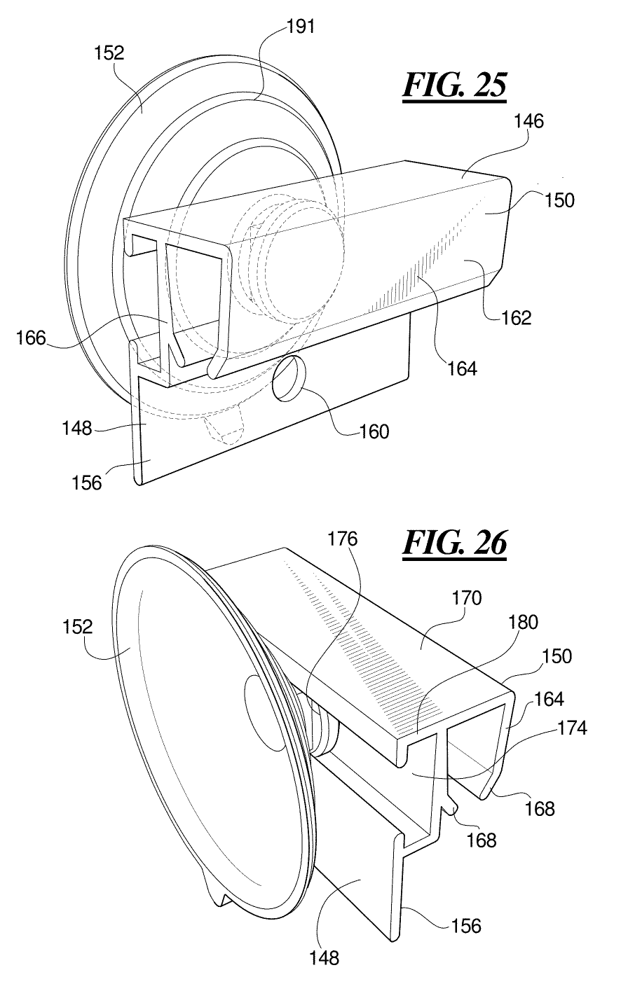

FIG. 25 shows the mounting portion 148 with the suction cup 152. The mounting portion 148 is configured for attachment to a window, or other glass or smooth surface. The mounting flange 156 and the hole 160 are not used in this mounting configuration.

In FIG. 26, the suction cup 152 is mounted to the mounting portion 148 by the button 176 being disposed in the channel 174. The shared wall of the back wall 178 and the second arm 166 is readily apparent.

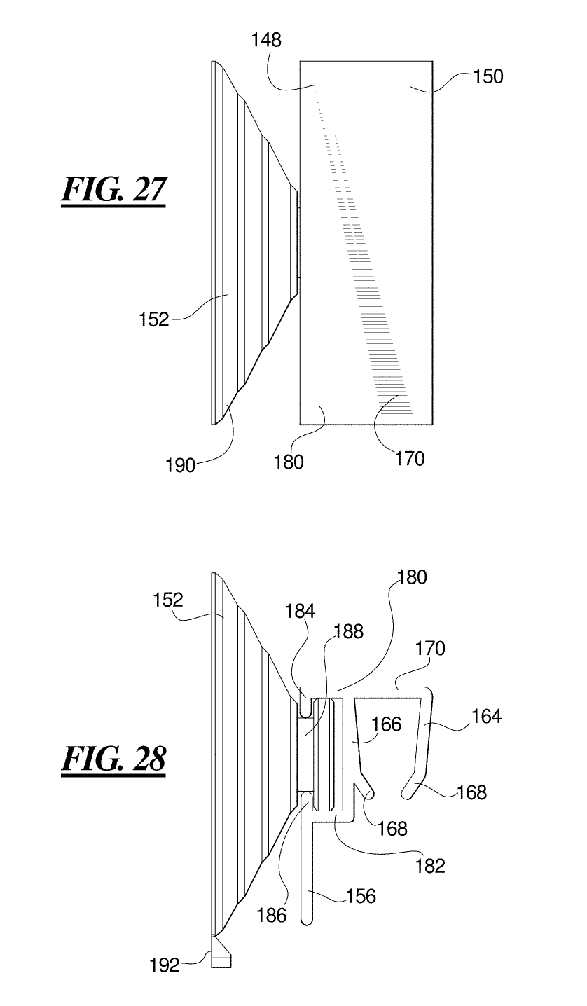

Turning to FIG. 27, the top wall 180 of the channel 174 and the cross member 170 of the frame gripper 162 form a continuous top surface on the flush mount embodiment. The suction cup 152 is preferably positioned in the channel 174 to be midway between the ends of the holder 150. The frame 142 is positioned in the holder midway along a side. The frame 142 is balanced to avoid tipping of the sign 140.

Lastly, FIG. 28 shows the button 176 of the suction cup 152 in the channel 174. The suction cup 152 is shown in a relaxed state. When affixed to a surface, the suction cup 152 flattens so that the mounting and holding apparatus 146 and the frame 142 is held close to the surface 144.

The flush mount embodiment may be reconfigured to mount on glass using a suction cup, to a wall using a screw or nail, or to a metal or other durable surface using adhesive Like each embodiment shown herein, the holder may hold a large frame, midsize frame or small frame. The frame may be square or rectangular, or of other shapes. The frame may be mounted in landscape or portrait orientation or other orientation. Large fames may use multiple mounting and holding apparatus attached along a side of the frame.

Embodiments of the mounting and holding apparatus that mount the frame to extend outward from the mounting location may be provided with either a hinged or non-hinged holder. Signs mounted in a location with a risk that the sign may be bumped by a passing person, for example, may be provided with the hinged holder. Multiple hinged holders on multiple mounting and holding apparatus may be provided for large frames.

The mounting portion may be selected according to the type of mounting location at which the sign is to be displayed. The mounting portion may be mounted to a mounting location having holes into which the mounting portion is inserted. In addition to the keyhole-shaped holes shown in the example, mounting using other holes may be possible, such as holes in pegboard, slotted board, or the like. By selecting a different mounting portion, the mounting portion may be mounted to a shelf or other mounting location. Mounting the sign to an underside of a shelf leaves the top of the shelf available to hold products or items. By selecting the magnetic mounting portion, the sign may be mounted to a mounting location of ferrous metal. The examples described herein are but a few of the many possible mounting portions that may be selected for mounting the sign. Other examples are shown in the provisional patent application for which a benefit has been claimed in this application, which provisional application is incorporated herein by reference.

The frame may be exchanged for frames of different sizes, shapes or colors. The contents of the frame may be changed easily. The frame permits signs or indicia to be displayed that might not be sturdy enough for display on their own. For example, the signs may be printed on standard paper or light duty card stock using an office printer and inserted into the frame for display. The signs may be standard printer paper size, or may be perforated or may be cut or folded to a correct size and shape. Even relatively easily produced signs are provided with an enhanced visual effect by mounting the sign in a frame, possibly with a clear cover sheet, and mounting the framed sign using the mounting and holding apparatus.

The present invention provides an apparatus and method for mounting a sign, object and other indicia at a mounting location. The figures show various embodiments of the apparatus in end or cross-sectional views as well as perspective views of the embodiments of the apparatus and photographs of the embodiments of the apparatus in use. The apparatus may include an extruded channel having a mounting portion for mounting the channel. The extruded channel may have a C-shaped portion having a generally planar back wall, inwardly angled side walls at a first angle, and inwardly angled end walls as a second angle, wherein the second angle is greater than the first angle. In certain aspects, all embodiments have the C-shaped portion.

Other embodiments, including those shown in the provisional application, may include an extruded channel that may have with a C-shaped portion and a mounting portion may include a flat plate parallel to the back plate of the C-shaped portion and connected thereto by a neck. The extruded channel may have the C-shaped portion and a mounting portion with lateral extensions extending from the back plate and provided with engaging portions on each of the lateral extension. The extruded channel may have the C-shaped portion and a mounting portion with engaging portions mounted to one of the angled side walls. An extension may extend generally perpendicular to the back plate from one of the engaging portions in a first direction relative to the C-shaped portion. The extension may include one or more holes in the extension. The extruded channel may have the C-shaped portion and a mounting portion with a mounting plate mounted to one of the angled side walls and may include an extension extending generally perpendicular to the back plate in a second direction relative to the C-shaped portion. An adhesive such as an adhesive tape may be provided on the mounting plate.

The extruded channel may have the C-shaped portion and a mounting portion that includes a plate extending generally perpendicular to the back plate in the second direction relative to the C-shaped portion and may extend generally from a center of the back plate. The extruded channel may have the C-shaped portion and a mounting portion that includes a mounting plate extending generally perpendicular to the back plate at one side thereof. A semi-cylindrical clip with a flange at an opening in the clip may be provided at an end of the mounting plate. The mounting plate and clip may be formed at two ends of the extruded channel and with a gap provided between the two clip ends.

A warehouse upright holder may have the C-shaped portion and a mounting portion to attach the holder to holes of an upright. A gondola upright holder may have the C-shaped portion and a mounting portion with hooks and flexible flanges to hold the holder to an upright. A telescopic gondola aisle holder may have the C-shaped portion and a telescoping arm and arm base to hold the holder to an upright. A tool-free telescopic gondola aisle holder may have the C-shaped portion and a telescoping arm and arm base to hold the holder to an upright. A telescopic pegboard aisle holder may have the C-shaped portion and a telescoping arm and arm base to mount to an upright pegboard. A pegboard holder may have the C-shaped portion and a mounting portion with a pegboard attachment.

A plastic shelf-top holder may have the C-shaped portion and a mounting portion to engage a top surface of a shelf. A metal shelf-top holder may have the C-shaped portion and a mounting portion to engage a top surface of a shelf. A plastic channel mount holder may have the C-shaped portion and a bracket and screw to attach the holder to a mounting location. A metal channel mount holder may have the C-shaped portion and a bracket and screw to attach the holder to a mounting location. An under-shelf spring-mount holder may have the C-shaped portion and a spring clip for attaching to an underside of a shelf. An under-shelf screw-mount holder may have the C-shaped portion and a screw clip for attaching to an underside of a shelf. An under-shelf hardware-mount holder may have the C-shaped portion and a bracket with screws and nuts to mount the holder to an underside of a shelf.

A magnetic under-shelf L-style holder may have the C-shaped portion and a magnet for attachment to an underside of a shelf in a horizontal position. A magnetic under-shelf holder may have the C-shaped portion and a magnet and bracket for attachment to an underside of a shelf with the holder in a vertical position. A “C” clamp aisle holder may have the C-shaped portion and a C clamp with screw to mount the holder in a vertical position. A magnetic holder may have the C-shaped portion and a magnetic mounting bracket. The holder may have a magnetic bracket mounted thereto.

A holder with adhesive may have the C-shaped portion and an adhesively mounted back plate. The holder may have an adhesive applied to the back plate. A flag suction cup holder may have the C-shaped portion and a suction cup for attachment to a surface. A flush suction cup holder may have the C-shaped portion and a suction cup on the holder. A wall mount holder kit may include a bracket, screw and screw anchor for use with the apparatus above. A flush mount magnetic holder may have the C-shaped portion and a magnet mounted to the side wall. A flush mount holder with adhesive may have the C-shaped portion and an adhesive on the side plate. A hanger clip may have the C-shaped portion and a plate with a hole for hanging the clip. A wire flush hanger clip may have two clips for mounting to a wire or other mounting location. A back mounting plate may have edge extensions for attachment to a base. The extensions may be added to an embodiment as described above.

Although other modifications and changes may be suggested by those skilled in the art, it is the intention of the inventors to embody within the patent warranted hereon all changes and modifications as reasonably and properly come within the scope of their contribution to the art.

I claim:

1. An extrusion, comprising:
a C-shaped frame gripper having inwardly angled walls at a first angle and inwardly angled ends on the walls at a second angle that is greater than the first angle; and
a mounting portion attached to the C-shaped frame gripper.

2. A modular sign system, comprising:
a mounting portion selected from a plurality of different mounting portions, the plurality of different mounting portions being configured for mounting at a plurality of corresponding different types of mounting locations;
a holder affixed to the mounting portions, the holder including a frame gripper; and
a frame mounted in the holder, the frame being configured for holding a sign such that the sign is mounted for viewing when held in the frame and when the frame is gripped in the holder and when the mounting portion is mounted at a mounting location.

3. A modular sign system as claimed in claim 2, wherein the holder includes a holder base affixed to the mounting portion.

4. A modular sign system as claimed in claim 3, wherein the holder includes a C-shaped frame gripper that extends perpendicular to the holder base so that the frame extends perpendicular to the holder base when mounted in the C-shaped frame gripper.

5. A modular sign system as claimed in claim 4, further comprising:
a hinge portion connected between the holder base and the C-shaped frame gripper of the holder, the hinge portion being configured to flex so that the C-shaped frame gripper may move relative to the holder base.

6. A modular sign system as claimed in claim 4, wherein the mounting portion includes a base plate, the base plate being connected to the holder base of the holder.

7. A modular sign as claimed in claim 6, wherein the base plate is connected to the holder base with adhesive.

8. A modular sign system as claimed in claim 2, wherein the mounting portion includes a base plate and first and second hooks extending rearwardly from the base plate, the hooks being configured to attach the mounting portion to a mounting location.

9. A modular sign system as claimed in claim 5, wherein the mounting portion includes a spring member having first and second spring portions connected at a middle and biased outward from one another, the first and second spring portions include engagement tabs configured for affixing the mounting portion at a mounting location, the mounting portion including an extender connected at the middle of the spring member and the base plate connected to the extender.

10. A modular sign system as claimed in claim 2, wherein the mounting portion includes a magnet mounted to a base plate.

11. A modular sign system as claimed in claim 1, wherein the mounting portion includes a suction cup and a channel wall connected to the suction cup.

12. A modular sign system as claimed in claim 11, wherein the holder has a frame gripper, the frame gripper extending perpendicular to an axis of the suction cup.

13. A method of mounting a sign, comprising:
selecting a mounting portion from a plurality of mounting portions, the selection depending on a mounting location to which the sign is to be mounted;
mounting the mounting portion to the mounting location;
inserting a sign into a frame; and
inserting the frame into a holder that extends from the mounting portion.

14. A method as claimed in claim 13, further comprising:
selecting a holder from a set of holders including a hinged holder and a non-hinged holder.
